(19) United States
(12) Patent Application Publication
(10) Pub. No.: US 2012/0179581 A1
(43) Pub. Date: Jul. 12, 2012

(54) Unused Service Units

(75) Inventors: Douglas David Gravino, Roswell, GA (US); Radhakrishnan Gopinath, Alpharetta, GA (US); Michael Lee Poffenberger, Atlanta, GA (US); Jeffrey Goran, Atlanta, GA (US)

(73) Assignee: COX COMMUNICATIONS, INC., Atlanta, GA (US)

(21) Appl. No.: 12/985,614

(22) Filed: Jan. 6, 2011

(51) Int. Cl. G06Q 30/00

(52) U.S. Cl. 705/27.1

(57) ABSTRACT

Allowing a subscriber of a service to use unused service units associated with a service plan to purchase products or services is provided. Unused service units (e.g., minutes of voice calling, number of text messages, megabytes of data, etc.) may be tracked and converted into units of value. An amount of redemption value units may be exchanged for one or more prescribed products or services. Options of redeemable products or services may be presented to the subscriber. Upon selection of one or more products or services, the selected product or service may be provided, and the subscriber's unused service units account balance may be reconciled.

### BACKGROUND

Many service providers offer and sell services and/or products that have a pre-defined quantity of service units included in a service plan. For example, many wireless and wireline telecommunications carriers may sell voice calling plans, messaging plans, and/or internet data plans that have a pre-defined quantity of minutes of voice calling, number of messages, and/or megabytes of data, etc. included in a service plan for an associated monthly price.

Subscribers of such services and/or products often purchase larger quantities of service units than they typically use in a given billing cycle. Consequently, many subscribers have an amount of unused service units at the end of a billing cycle. Service providers often use a variety of methods to increase the perceived value of customers' unused service units. For example, a service provider may allow for a balance of unused service units (e.g., wireless voice minutes, etc.) to be accrued and available for utilization in future billing cycles. For another example, subscribers may be entitled to be reimbursed up to a predetermined dollar amount per billing cycle for unused service units on their contract service plan. While current systems provide some benefits to subscribers, current systems do not extend the value of unused service units beyond use with the existing communications service plan.

It is with respect to these and other considerations that the present invention has been made.

### SUMMARY

Embodiments of the present invention provide for allowing a subscriber of a service or product to use unused service units associated with a service plan to purchase products or services. That is, unused service units may be used as a form of currency for purchasing other services or products. At the end of a billing cycle, service units included in a subscriber's service plan that have not been used may be accumulated, converted into a unit of value, and may be redeemed for exchange with a service provider or merchant for an offered product or service provision. Unused service units may be treated as an adjustably-rated stored value, a unit of exchange, or as a variable multiplier. For example, at the end of a month, a wireless communications subscriber may have one hundred unused voice minutes available under his/her wireless subscription plan. The unused voice minutes may be converted into a unit of value. For example, one unused voice minute may equate to $0.01 that may be used toward the purchase of a new wireless communications device (e.g. mobile phone). According to embodiments, any number of exchange/redemption offerings may be presented to the subscriber for using unused service units toward various products or services.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

FIG. 1 is simplified block diagram illustrating a communication network architecture that serves as an exemplary operating environment for the present invention.

FIG. 2 is a simplified block diagram illustrating a computing device with which embodiments of the present invention may be practiced.

FIG. 3 is a simplified block diagram illustrating an example screenshot on a mobile computing device according to embodiments of the present invention.

FIG. 4 is a flow diagram showing an illustrative routine for accumulating, tracking, processing, updating, and outputting unused service units.

### DETAILED DESCRIPTION

As briefly described above, embodiments of the present invention are directed to allowing a subscriber of a service to use unused service units associated with a service plan to purchase products or services. Unused service specific units (e.g., minutes of voice calling, number of text messages, megabytes of data, etc.) may be tracked and converted into units of value. A predetermined amount of unused service units (hereafter “USU”) may be exchanged for one or more prescribed products or service provisions. Options of products or services for which USUs may be exchanged and an exchange value of each product and service may be presented to a subscriber. Upon selection of one or more products or services, the selected product or service may be provided, and the subscriber's USU account balance may be reconciled.

As an example, a subscriber to a wireless communications service may redeem a quantity of USUs for additional data communication capacity for accessing the Internet. As another example, a subscriber of a wireless communications service may redeem a quantity of USUs for wireless products such as a new wireless phone, wireless phone accessories, and the like. As another example, a service provider may offer services other than wireless communications, such as cable television (CATV) services, Internet services, or land-line telephone services. In such a case, a subscriber may have purchased bundled services including all, or portions of the example services/products. According to this example, USUs may be redeemed for CATV service discounts, pay-per-view movies, additional domestic or international land-line telephone minutes, and the like. As yet another example, a service provider may provide products and/or services outside of its core business through a network of vendors and may allow for redemption of USUs for various products and/or services such as, but not limited to, airline travel, hotel stays, donations to charities, gift cards, as well as various other products and services. As should be appreciated, USUs converted to units of value (e.g., 1000 unused voice minutes converted to a $10 gift certificate) may be used to purchase or subscribe to any product or service whose provider agrees to take the converted units of value toward the purchase or subscription.

These embodiments may be combined, other embodiments may be utilized, and structural changes may be made without departing from the spirit or scope of the present invention. The following detailed description is therefore not to be taken in a limiting sense, and the scope of the present invention is defined by the appended claims and their equivalents. Referring now to the drawings, in which like numerals refer to like elements throughout the several figures, embodiments of the present invention and an exemplary operating environment will be described.

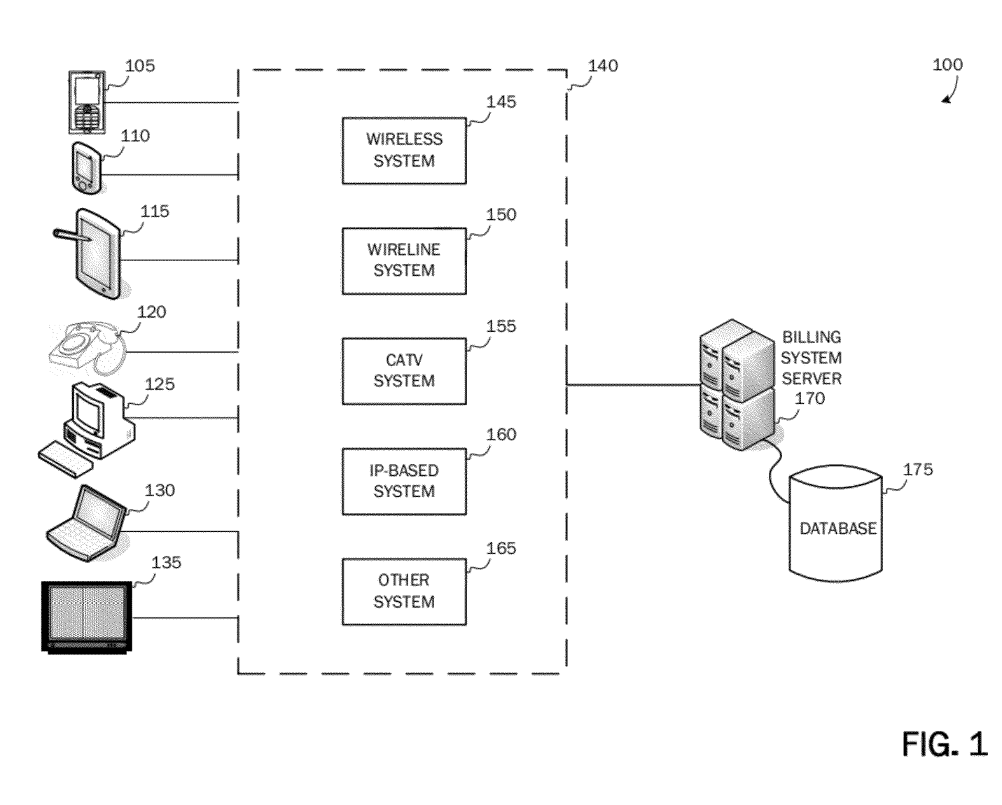

FIG. 1 is simplified block diagram illustrating a communication network architecture that serves as an exemplary operating environment for the present invention. In FIG. 1, a variety of communications devices and systems are illustrated for which service units may be purchased but not used and for which USUs may be redeemed for other purposes as described herein. A variety of endpoint devices are illustrated including, but not limited to, wireless telephones 105, mobile communications devices 110, Personal Digital Assistants (PDA) 115, wireline telephones 120, personal computers 125, laptop computers 130, television/set-top box combinations 135, etc. to communicate with one or more remote applications or other endpoint devices via a communications network 140. As should be appreciated, the numerous endpoint devices illustrated in FIG. 1 may be utilized to send and/or receive communications in various operating environments according to various types of transmissions.

The Network 140 is illustrative of one or more communications systems through with the various endpoint devices/systems may operate. For example, the wireless system 145 may be utilized for wireless voice, text and data transmissions. The wireline system 150 may be utilized for wireline voice, text and data transmissions. The Cable Television (CATV) system 155 may be utilized for provision of television services, telephone services and data services. The IP-based system 160 may be utilized for any of a variety of Internet protocol-based services such as voice and data transmissions. Other systems 165 are illustrative of any number of other systems that may be utilized for providing communications between various endpoint devices with other endpoint devices, software applications and data repositories. For example, a single combined system may be provided by a given service provider for providing multiple types of the aforementioned communications services. For example, a single services provider may offer television, wireless and wireline telephone and data services.

Referring still to FIG. 1, a billing system 170 and associated database 175 may serve as a central computerized tracking, processing, storage, and outputting system according to the embodiments of this invention. The billing system 170 is illustrative of any suitable computing system (e.g., server computer), capable of sending, receiving, processing, and tracking data according to embodiments of the present invention. The billing system 170 may be associated with any one or combination of the communications systems illustrated in the network 140 for maintaining and processing subscriber information, including but not limited to, products or services subscribed to, contract information, subscriber contact information, product/services usage data, as well as, all necessary billing functionality. The associated database 175 may be operative for storing information for various subscribers.

According to embodiments, the billing system server 170 and associated database 175 may be utilized for tracking and processing a subscriber's/customer's account usage and for converting USUs to adjustably-rated stored values, units of exchange or as variable multipliers as described herein. For example, the billing system may track, process, update and output account balances for each service provided to the subscriber/customer. For example, a user of a wireless system may wish to redeem USUs to purchase or redeem a new wireless phone. A unit of exchange may be calculated, for example, each unused voice calling minute may equate to $0.01 toward the purchase of the example wireless phone. Adjustably-rated stored value may allow for different redemption values for different levels of USUs. For example, a first range of USUs of 1-100 unused voice minutes may equate to $1.00 in redemption value; a second range of USUs of 101-200 unused voice minutes may equate to $4.00 in redemption value; a third range of USUs of 201-300 unused voice minutes may equate to $8.00; and so on. A variable multiplier system may be used wherein, for example, for every minute of unused voice calling service, five text messages are redeemed. That is, redemption value conversion rates may be fixed or variable and may be determined by the service provider and implemented into the billing system 170 or other computerized system responsible for tracking, processing, updating, and outputting service plan USUs and associated redemption values. As should be appreciated, these are but a few examples of the many ways a service/product provider may convert USUs to value units that may be used for redemption of other services or products or that may be used to incentivize a customer or subscriber to purchase and utilize more of the provider's services/products.

According to embodiments, on a periodic basis, for example, weekly or monthly, the billing system database 175 may be parsed by the billing system 170 to retrieve account information and a current USU balance, verify available USUs, and calculate redemption values. Upon receiving redemption orders from subscribers, as described below, the billing system 170 may authorize the redemption orders, process redemption transactions, and reconcile the subscriber's USU balances. Communications may be sent to the subscriber from the billing system 170 via an appropriate communication system of a successful redemption transaction, as well as, updated USU balance information. Updated USU information may be stored in the database 175.

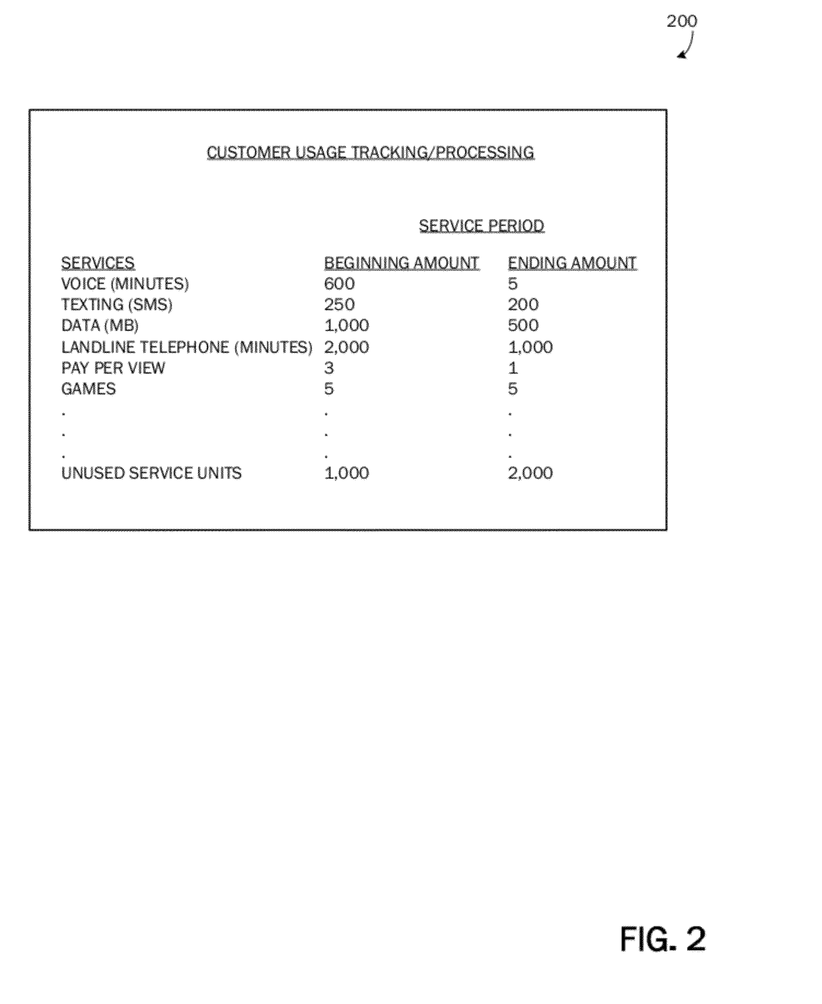

Referring now to FIG. 2, example USU information associated with a service account is illustrated. As described above, USU information may be stored and processed by a billing system server 170 and associated database 175. As illustrated, account service unit balance data may be provided for various services including, but not limited to, voice, texting, data, telephone (wireless and wireline), pay-per-view, games, and the like. The information tracked, processed, updated, and outputted may include beginning and ending balances of each of the service for a given service period. As should be appreciated, the information illustrated in FIG. 2 shows a number of services and associated usage tracking information, but for a given subscriber, a single service, for example, wireless voice calling usage, may be tracked.

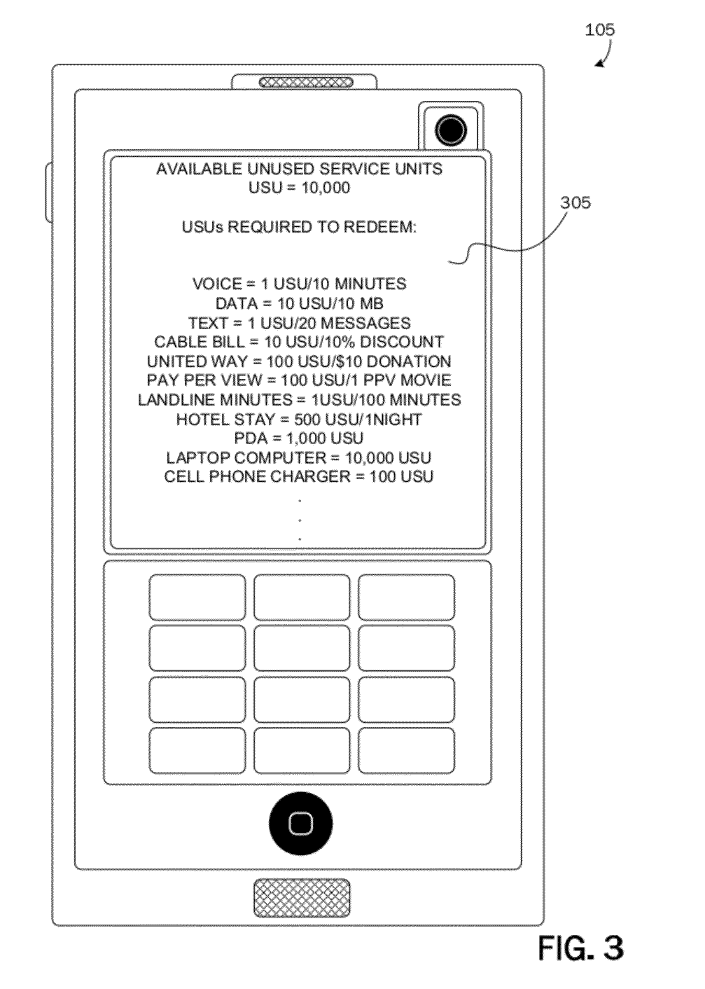

As USUs and associated redemption values are processed at the billing system 170, a reporting of the processed information may be presented to the subscriber to allow the subscriber to review his/her USU balance and redemption values and to allow the subscriber to purchase services and/or products with his/her redemption values. The reporting of the processed information may be made to the subscriber via any of the communications endpoints described above or via other conventional methods such as hard-copy mailing. Referring now to FIG. 3, a mobile communication device (e.g., mobile telephone) 105 is illustrated as one example for displaying a USU user interface screen with available USUs and USU redemption value information. As should be appreciated, a USU user interface 305 may be displayed on any other suitable network-connected computing device display, wherein the computing device is operative to receive and display USU data. As illustrated in FIG. 3, a USU user interface screen 305 may include a user's available USUs and a listing of redemption values associated with products and services available for exchange or redemption. That is, USUs and a quantity of USUs required for exchange or redemption of each product or service may be presented to the subscriber.

According to embodiments of the present invention, redemption values may be used to redeem one or more products or services. Referring to the example USU user interface 305 in FIG. 3, a user may be provided with USU redemption information. For example and as illustrated, one (1) USU may be exchanged for 10 additional minutes of voice calling time. One or more products or services may be selected by a user by various ways known in the art. For example, on a mobile phone 105 with a touch screen interface, a user may touch on a displayed product or service to select the product or service. As another example and as illustrated, 100 USUs may be exchanged for one (1) pay-per-view movie. As should be appreciated, the redeeming disposition options illustrated in FIG. 3 are for purposes of example and are not limiting of other options that may be available according to embodiments of the invention. For example, a subscriber may be presented options for using redemption values outside the associated service provider such as at a department store or the like.

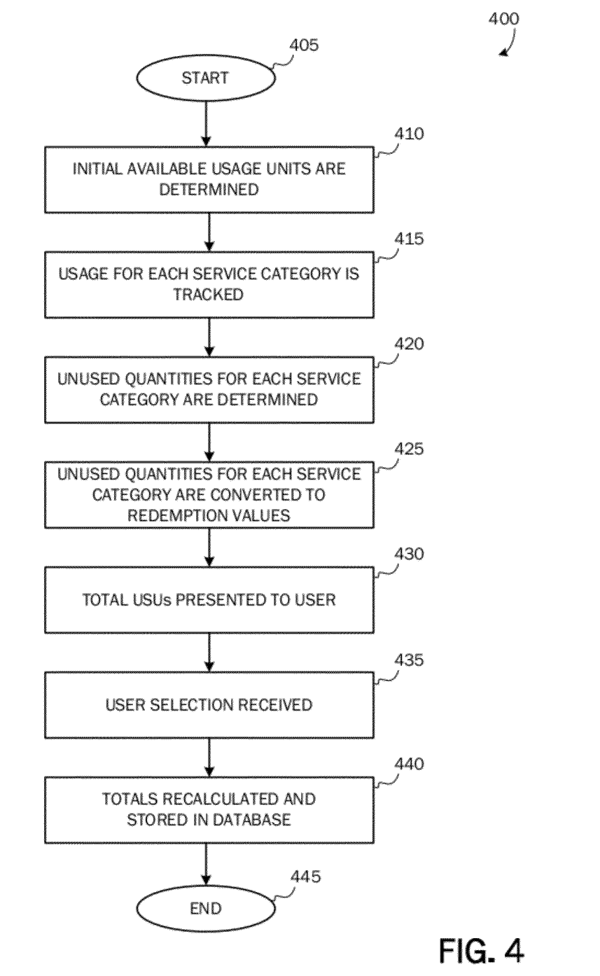

Referring now to FIG. 4, a flow diagram of an illustrative routine 400 for tracking USUs, converting the unused service specific units into a unit of redemption value and allowing for the USUs to be exchanged for one or more products or services is illustrated. The routine begins at OPERATION 405 and proceeds to OPERATION 410 where initial available service units are determined. Available service units may be received from a billing system 170 and a billing system database 175. Available service units may include a balance of usage units currently available for one or more services according to a service plan purchased by a subscriber. For example, available service units for a wireless service plan may include a number of available minutes of talk time during a billing cycle, a number of text, picture, video, and/or instant messages that may be sent during a billing cycle, and an amount of data usage during a billing cycle for such activities as surfing the web, sending email, visiting social networking sites, streaming music, downloading videos, files, and applications, etc. The balance of usage units may include USUs carried over from a previous billing cycle. Other examples of available service units may include unused wireline voice and data communications units, unused television system units, such as prepaid movies, programs, games, etc. or any other service units for any other system that have been purchased but not used by the subscriber.

During a given billing cycle, at OPERATION 415, the subscriber's consumption of services is tracked for each service category allowed under his/her service plan. That is, a subscriber's usage may be monitored. For example, when a call is made or received on a wireless device, the length of the call may be monitored. The length of the call may be deducted from the available number of voice minutes provided per the subscriber's service plan. As should be appreciated, other usage data may be monitored and tracked including, but not limited to, messaging, data usage, pay-per-view purchases, and gaming purchases or usage, and the like.

The routine 400 proceeds to OPERATION 420, where at the end of a billing cycle or at any prescribed frequency, unused quantities of service units for each service category may be determined. That is, a quantity of used units of a service may be deducted from an available quantity of service units according to a user's service plan. For example, if a subscriber has a wireless service plan including 700 minutes of voice calling, and he/she has used 600 minutes, it may be determined that he/she has 100 USUs of voice calling.

The routine 400 proceeds to OPERATION 425 where a predetermined fixed or variable rate may be applied to each service category to convert the unused service-specific units into a type of credit that may be applied to one or more products or services. For example, a predetermined rate may be applied to unused text messages so that a block of ten unused text messages may be redeemed for $1.00 towards a purchase of a new communication device. A predetermined rate may be applied to unused voice minutes so that each unused minute may be redeemed for $0.01 towards a purchase of text messages. As should be appreciated, any number of variable rates may also be used as described above.

At OPERATION 430, USU balances, converted redemption values and one or more products or services that may be purchased with redemption values may be presented to the user. An example user interface showing a USU balance and various products and services is illustrated and described with respect to FIG. 3. As described above, various products or services may be offered for redemption. According to embodiments, USUs may be redeemed toward making purchases of various wireless communications devices, accessories, and the like. USUs may also be converted into another stored value unit such as frequent flyer miles, loyalty card program points, gift cards or other forms of corporate coupon, community coupon, and the like. According to other embodiments, redemption values may be donated to various charitable organizations (e.g., free minutes of calling for Armed Forces members serving overseas) or converted per a predetermined rate into a cash donation to various charities (e.g., $5 to the RED CROSS for every 100 USUs). According to other embodiments, USUs may be converted into cash, cash-equivalents, or coupons in a form that may be given as a gift to a user-selected person (e.g., 100 USUs may be redeemed into a $5 gift card at a selected restaurant and gifted to a friend or relative). According to other embodiments, USUs may be exchanged for other related services. For example, 100 USUs in a given billing cycle may be exchanged for one free pay-per-view movie. As another example, 100 USUs may be exchanged for twenty-five additional text messages. According to another embodiment, USUs may be used as a multiplier for discounts or bonuses on variable-cost/value items. For example, 100 USUs may be worth a 10% discount on the subscriber's metered landline international long-distance bill. As should be appreciated, the above examples are meant for illustrative purposes and do not reflect an exhaustive list of possible uses.

The routine 400 proceeds to OPERATION 435 where user input is received. User input may include a selection for redemption of a product or service. Alternatively, user input may include a selection for redemption of cash or coupons or other forms of currency for use at participating businesses and organizations. At OPERATION 440, a determination may be made that selections made by the subscriber do not exceed the balance of available USU redemption values. The subscriber's USU account balance may be recalculated to reflect transactions made.

After receipt of a redemption selection, the selected redemption product or service may be provided. If the selected product or service may be provided by a service provider responsible for the USUs, the selected product may be automatically provided or scheduled for provision. For example, if the subscriber selects for redemption a quantity of text messages in exchange for unused voice calling minutes, the billing system 170 may be automatically updated to reflect that the subscriber now is credited with the additional text messages without charge. On the other hand, if the subscriber selects for redemption a product or service not available from the service provider responsible for the USUs, a coupon, check (cash) or other form of currency may be generated and sent to the subscriber via the billing system 170 via electronic or physical (mail) delivery so that the subscriber may use the redeemed value for purchasing a desired product or service (e.g., an electronic device or accessory from an appropriate purchasing point) or for donating the redeemed value to a desired person or organization. The routine 400 ends at OPERATION 445.

Although described herein with respect to setup changes to various electronic devices via server side and or client side applications, in alternative embodiments, the invention may be used in combination with any number of computer systems, such as in desktop environments, laptop or notebook computer systems, multiprocessor systems, micro-processor based or programmable consumer electronics, network PCs, mini computers, main frame computers and the like. Embodiments of the present invention may be utilized in various distributed computing environments where tasks are performed by remote processing devices that are linked through a communications network in a distributed computing environment.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention. Although embodiments of the present invention have been described with reference to particular standards and protocols, the present invention is not limited to such standards and protocols.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A method of tracking and converting unused service units into a unit of value for redemption of a product or service, the method comprising:
monitoring usage associated with a service associated with a subscriber service plan;
determining a balance of unused service units associated with a use of the service associated with a subscriber service plan;
converting unused service units into a unit of value for redemption of a product or service;
presenting an unused service units balance and associated unit of value for redemption and a listing of products and/or services for which a prescribed quantity of unit values for redemption may be used for purchasing one or more of the listed products and/or services; and
receiving an indication of a selection of one or more products and/or services for redemption in exchange for a prescribed quantity of unit values for redemption.

2. The method of claim 1, after receiving an indication of a selection of one or more products and/or services for redemption in exchange for a prescribed quantity of unit values for redemption, calculating and storing a balance of unused service units and associated unit of value for redemption.

3. The method of claim 1, wherein converting unused service units into a unit of value for redemption of a product or service includes converting the unused service units into a unit of value for redemption based on a fixed rate of conversion where one unused service unit equals a fixed unit of value for redemption.

4. The method of claim 1, wherein converting unused service units into a unit of value for redemption of a product or service includes converting the unused service units into a unit of value for redemption based on a variable rate of conversion where a first range of unused service units equals a first unit of value for redemption and where a second range of unused service unites equals a second unit of value for redemption.

5. The method of claim 1, wherein receiving an indication of a selection of one or more products and/or services for redemption in exchange for a prescribed quantity of unit values for redemption includes receiving an indication of a selection of one or more products and/or services provided by a service provider responsible for providing the service associated with a subscriber service plan and in response to receiving an indication of a selection of one or more products and/or services for redemption in exchange for a prescribed quantity of unit values for redemption, automatically providing the selected one or more products and/or services to the subscriber.

6. The method of claim 1, wherein receiving an indication of a selection of one or more products and/or services for redemption in exchange for a prescribed quantity of unit values for redemption includes receiving an indication of a selection of one or more products and/or services not provided by a service provider responsible for providing the service associated with a subscriber service plan and in response to receiving an indication of a selection of one or more products and/or services for redemption in exchange for a prescribed quantity of unit values for redemption, providing the subscriber a form of currency for use in purchasing the selected one or more products and/or services.

7. The method of claim 1, wherein monitoring usage associated with a service associated with a subscriber service plan includes monitoring usage of one of a wireless voice service, a wireless texting service, a wireless data service, a wireline voice service, a wireline texting service, a wireline data service a service, an Internet-based voice service and Internet-based data service, a cable television service-based television service, a cable television service-based telephone service, and a cable television service-based data service.

8. The method of claim 1, further comprising processing unused service units and units of value for redemption at a billing system associated with a service provider responsible for providing the service associated with a subscriber service plan.

9. A computer readable medium containing computer executable instructions which when executed by a computer perform a method of tracking and converting unused service units into a unit of value for redemption of a product or service, the method comprising:
monitoring usage associated with a service associated with a subscriber service plan;
determining a balance of unused service units associated with a use of the service associated with a subscriber service plan;
converting unused service units into a unit of value for redemption of a product or service; and
presenting an unused service units balance and associated unit of value for redemption and a listing of products and/or services for which a prescribed quantity of unit values for redemption may be used for purchasing one or more of the listed products and/or services.

10. The computer readable medium of claim 9, further comprising receiving an indication of a selection of one or more products and/or services for redemption in exchange for a prescribed quantity of unit values for redemption.

11. The computer readable medium of claim 10, after receiving an indication of a selection of one or more products and/or services for redemption in exchange for a prescribed quantity of unit values for redemption, calculating and storing a balance of unused service units and associated unit of value for redemption.

12. The computer readable medium of claim 9, wherein converting unused service units into a unit of value for redemption of a product or service includes converting the unused service units into a unit of value for redemption based on a fixed rate of conversion where one unused service unit equals a fixed unit of value for redemption.

13. The computer readable medium of claim 9, wherein converting unused service units into a unit of value for redemption of a product or service includes converting the unused service units into a unit of value for redemption based on a variable rate of conversion where a first range of unused service units equals a first unit of value for redemption and where a second range of unused service unites equals a second unit of value for redemption.

14. The computer readable medium of claim 9, wherein receiving an indication of a selection of one or more products and/or services for redemption in exchange for a prescribed quantity of unit values for redemption includes receiving an indication of a selection of one or more products and/or services provided by a service provider responsible for providing the service associated with a subscriber service plan and in response to receiving an indication of a selection of one or more products and/or services for redemption in exchange for a prescribed quantity of unit values for redemption, automatically providing the selected one or more products and/or services to the subscriber.

15. The computer readable medium of claim 9, wherein receiving an indication of a selection of one or more products and/or services for redemption in exchange for a prescribed quantity of unit values for redemption includes receiving an indication of a selection of one or more products and/or services not provided by a service provider responsible for providing the service associated with a subscriber service plan and in response to receiving an indication of a selection of one or more products and/or services for redemption in exchange for a prescribed quantity of unit values for redemption, providing the subscriber a form of currency for use in purchasing the selected one or more products and/or services.

16. The computer readable medium of claim 9, wherein monitoring usage associated with a service associated with a subscriber service plan includes monitoring usage of one of a wireless voice service, a wireless texting service, a wireless data service, a wireline voice service, a wireline texting service, a wireline data service a service, an Internet-based voice service and Internet-based data service, a cable television service-based television service, a cable television service-based telephone service, and a cable television service-based data service.

17. A system for tracking and converting unused service units into a unit of value for redemption of a product or service, the system comprising:
a communications system billing system operative
to monitor usage associated with a service associated with a subscriber service plan;
to determine a balance of unused service units associated with a use of the service associated with a subscriber service plan;
to convert unused service units into a unit of value for redemption of a product or service; and
to present an unused service units balance and associated unit of value for redemption and a listing of products and/or services for which a prescribed quantity of unit values for redemption may be used for purchasing one or more of the listed products and/or services.

18. The system of claim 17, wherein the communications system billing system is further operative
to receive an indication of a selection of one or more products and/or services for redemption in exchange for a prescribed quantity of unit values for redemption; and
to calculate and store a balance of unused service units and associated unit of value for redemption after receiving an indication of a selection of one or more products and/or services for redemption in exchange for a prescribed quantity of unit values for redemption,

19. The system of claim 18, wherein the communications system billing system is further operative to convert the unused service units into a unit of value for redemption based on a fixed rate of conversion where one unused service unit equals a fixed unit of value for redemption or based on a variable rate of conversion where a first range of unused service units equals a first unit of value for redemption and where a second range of unused service unites equals a second unit of value for redemption.

20. The system of claim 17, wherein the communications system billing system is operative to monitor usage associated with a service associated with a subscriber service plan including monitoring usage of one of a wireless voice service, a wireless texting service, a wireless data service, a wireline voice service, a wireline texting service, a wireline data service a service, an Internet-based voice service and Internet-based data service, a cable television service-based television service, a cable television service-based telephone service, and a cable television service-based data service.
